(19) United States
(12) Patent Application Publication
(10) Pub. No.: US 2021/0146883 A1
(43) Pub. Date: May 20, 2021

(54) METHOD AND APPARATUS FOR CONTROLLING MOVING OBJECT USING IDENTIFICATION DEVICE FOR A PLURALITY OF USERS

(71) Applicants: Hyundai Motor Company, Seoul (KR); Kia Motors Corporation, Seoul (KR)

(72) Inventors: Jae Jun Ha, Hwaseong (KR); Young Jun Moon, Sejong (KR)

(21) Appl. No.: 17/038,445

(22) Filed: Sep. 30, 2020

(30) Foreign Application Priority Data
Nov. 14, 2019 (KR) 10-2019-0146033

(51) Int. Cl. B60R 25/24; H04L 29/06; B60R 25/01; B60W 60/00; B60W 40/08

(52) U.S. Cl. CPC B60R 25/241; H04L 63/0853; H04W 4/48; B60W 60/001; B60W 40/08; B60R 25/01

(57) ABSTRACT

A method of operating a moving object to which an identification device is applied includes steps of: receiving login information of a user of a plurality of users registered in the identification device; determining a result of a login authentication procedure with respect to the user processed by identification device, wherein the login authentication procedure comprises identifying the user based on the login information; and controlling the moving object based on moving object control information corresponding to the identified user when the login authentication procedure is completed.

### CROSS REFERENCE TO RELATED APPLICATION

The present application claims under 35 U.S.C. § 119(a) the benefit of Korean Patent Application No. 10-2019-0146033, filed on Nov. 14, 2019, the entire contents of which are incorporated by reference herein.

### BACKGROUND

### 1. Technical Field

The present disclosure relates to a method and apparatus for controlling a moving object using an identification device for a plurality of users.

### 2. Description of the Related Art

Subscriber identity modules (SIMs) are used in smart devices or smartphones. In addition, universal subscriber identity module (USIM) technology is an evolution of a SIM card and may be a step up from the SIM used in a global system for mobile communications (GSM). Herein, the USIM may be a small chip essentially inserted into a third-generation mobile communication (WCDMA) terminal capable of video calling. The USIM includes a small CPU and a memory. The CPU may identify a user using an encryption/decryption function and the memory may be used as a storage space for additional services. The USIM has been used in various forms. Such a SIM card is applicable to a moving object, which will be described below.

### SUMMARY

An object of the present disclosure is to provide a method and apparatus for controlling a moving object using an identification device.

Another object of the present disclosure is to provide a method and apparatus for identifying a user of a moving object based on an identification device and providing a service to the identified user.

Another object of the present disclosure is to provide a method and apparatus for enabling a plurality of users to control a moving object using one identification device.

The present disclosure relates to a method and apparatus for operating a moving object, to which an identification device is applied. The following embodiments are commonly applicable to a method and apparatus for operating a moving object according to the present disclosure.

According to an embodiment of the present disclosure, a method of operating a moving object, the method comprises receiving login information of a user of a plurality of users registered in the identification device; determining a result of a login authentication procedure with respect to the user processed by identification device, wherein the login authentication procedure comprises identifying the user based on the login information; and controlling the moving object based on moving object control information corresponding to the identified user when the login authentication procedure is completed.

The moving object control information includes common information corresponding to the plurality of users registered in the identification device and user-specific information corresponding to each of the plurality of users registered in the identification device.

The moving object control information may be updated based on moving object operation information of the identified user.

When at least one of users registered in the identification device operates the moving object, the common information and the user-specific information may be distinguishably stored, managed and updated based on the moving object operation information of the at least one of users.

When at least one of users is registered in the identification device, the identification device may receive user registration information corresponding to unique information of the user who has requested user registration, and perform a registration authentication procedure with respect to the user based on registration authentication information.

When the registration authentication procedure is completed, initial user information may be generated based on the user registration information.

The registration authentication information may correspond to information capable of being acquired from a user authorized for registration, and the initial user information may include the login information.

The moving object control information may be generated based on the initial user information.

When at least one of users is additionally registered in the identification device, a server may receive an additional request from the identification device, and perform an additional authentication procedure with respect to the additionally registered users based on information received from user devices.

The identification device may be embedded in the moving object.

When a guest user who is not registered in the identification device operates the moving object, a guest identification device different from the identification device may be used.

The guest identification device may be detachable from the moving object.

When the moving object is turned on or riding of a user is detected, the moving object may recognize the identification device.

The identification device may receive the login information from a moving object or a user device and perform the login authentication procedure.

The identification device may receive login information from a user device via a network and perform a login authentication procedure with respect to the user, when the moving object is turned off or riding of the user is not detected.

The common information may include status information of the moving object.

The user-specific information may include at least one of a position of a driver's seat, a height of the driver's seat, a color of an interior lighting, brightness of the interior lighting, a position of a room mirror, an angle of the room mirror, a position of a side-view mirror, an angle of the side-view mirror, an inside temperature, an angle of a steering wheel, tire pressure, an autonomous driving function setting variable, a transmission setting mode, a dashboard mode, navigation settings, content settings, and a wireless communication connection mode.

When the identification device identifies the user based on the login information, the user may be identified based on at least one of an authentication key, image recognition, fingerprint recognition, iris recognition, facial recognition, and voice recognition.

The moving object control information may include information on a type of a network used by the user, and the information on the type of the network may be generated and managed as the user-specific information of each user.

According to another embodiment of the present disclosure, a moving object to which an identification device is applied, the moving object comprises a transceiver configured to transmit and receive a signal; and a processor configured to control the transceiver, wherein the processor is configured to: receive login information of a user of a plurality of users registered in the identification device, and determine a result of a login authentication procedure with respect to the user processed by identification device, wherein the login authentication procedure comprises identifying the user based on the login information; and control the moving object based on moving object control information corresponding to the identified user when the login authentication procedure is completed.

According to another embodiment of the present disclosure, a system comprises: a moving object; and an identification device, wherein the moving object is configured to: receive login information of a user of a plurality of users registered in the identification device, and determine a result of a login authentication procedure with respect to the user processed by identification device, and control the moving object based on moving object control information corresponding to the identified user when the login authentication procedure is completed, wherein the identification device is configured to: identify the user based on the login information, and perform the login authentication procedure with respect to the user.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view illustrating a method of performing communication between a moving object and other devices;

FIGS. 2A to 2D are views illustrating a method of applying an identification device to a moving object;

FIGS. 3A to 3C are views illustrating a method of installing a plurality of identification devices in a moving object;

FIGS. 4A and 4B are views illustrating the case where a plurality of users uses a moving object using one SIM, according to an embodiment of the present disclosure;

FIGS. 5A and 5B are flowcharts illustrating an initial authentication process of preset users, according to an embodiment of the present disclosure;

FIG. 6 is a flowchart illustrating the case where a user is added in addition to the preset users, according to an embodiment of the present disclosure;

FIGS. 7A to 7D are flowcharts illustrating the case where an identification device performs authentication for login and a moving object is controlled, according to an embodiment of the present disclosure;

FIG. 8 is a view illustrating moving object control information stored and managed in an identification device, according to an embodiment of the present disclosure;

FIG. 9 is a view illustrating another example of moving object control information related to communication stored and managed in an identification device, according to an embodiment of the present disclosure;

FIG. 10 is a view illustrating an example of a method of generating moving object control information stored and managed in an identification device, according to an embodiment of the present disclosure;

FIG. 11 is a view illustrating a moving object including an identification device according to an embodiment of the present disclosure;

FIG. 12 is a view illustrating an example of a mobility power transmission system;

FIGS. 13 and 14 are views showing the configuration of an identification device; and

FIG. 15 is a view illustrating the configuration of a moving object according to another embodiment of the present disclosure.

### DESCRIPTION OF THE PREFERRED EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween.

In the present disclosure, the terms first, second, etc. are only used to distinguish one element from another and do not limit the order or the degree of importance between the elements unless specifically mentioned. Accordingly, a first element in an embodiment could be termed a second element in another embodiment, and, similarly, a second element in an embodiment could be termed a first element in another embodiment, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of the present disclosure and the way of attaining them will become apparent with reference to embodiments described below in detail in conjunction with the accompanying drawings. Embodiments, however, may be embodied in many different forms and should not be constructed as being limited to example embodiments set forth herein. Rather, these embodiments are provided so that this disclosure will be complete and will fully convey the scope of the disclosure to those skilled in the art.

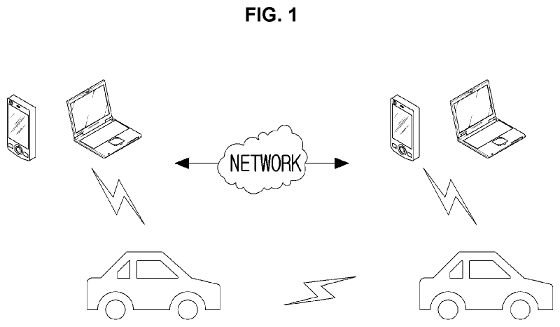

FIG. 1 is a view illustrating a method of performing communication with another moving object or a device via a network by a moving object. Referring to FIG. 1, the moving object may perform communication with another moving object or another device. For example, the moving object may perform communication with another moving object or another device based on cellular communication, WAVE communication, DSRC (Dedicated Short Range Communication) or other communication schemes. That is, an LTE or 5G communication network, a Wi-Fi communication network, a WAVE communication network, etc. may be used as a cellular communication network. In addition, a short-range communication network used in a moving object, such as DSRC, may be used, but the present disclosure is not limited thereto.

In addition, for example, in relation to communication of the moving object, an internal-communication module for performing communication only with a device located inside the moving object and an external-communication module capable of performing communication with a device located outside the moving object may be separately provided, for security of the moving object. For example, the internal-communication module may communicate with a device in a certain range of the moving object using a communication network such as Wi-Fi communication network. For example, the moving object and a device privately owned by the driver of the moving object may include the internal-communication module respectively for performing mutual communication with each other. That is, the moving object and the device privately owned by the driver of the moving object may use the internal-communication module disconnected from an external communication network. In addition, for example, the moving object may include the external-communication module for performing communication with an external device. In addition, for example, the internal-communication module and the external-communication module may be implemented in one physical module. That is, the moving object may perform communication with another device based on one physical module, but the present disclosure is not limited thereto. That is, in the moving object, the communication method may be implemented based on various methods, but the present disclosure is not limited thereto.

At this case, for example, the moving object may refer to a movable device. For example, the moving object may include a vehicle (including an autonomous vehicle and an automated vehicle), a drone, a mobility, a mobile office, a mobile hotel, or a personal air vehicle (PAV). In addition, the moving object may include the other movable devices, but the present disclosure is not limited thereto.

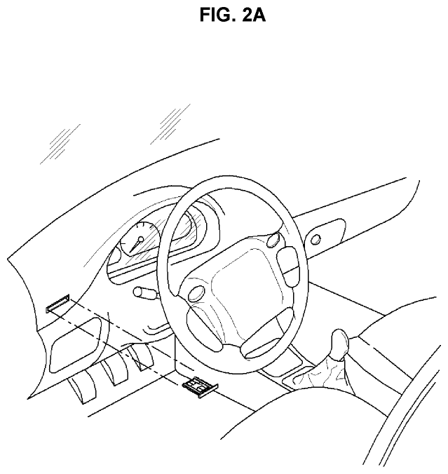

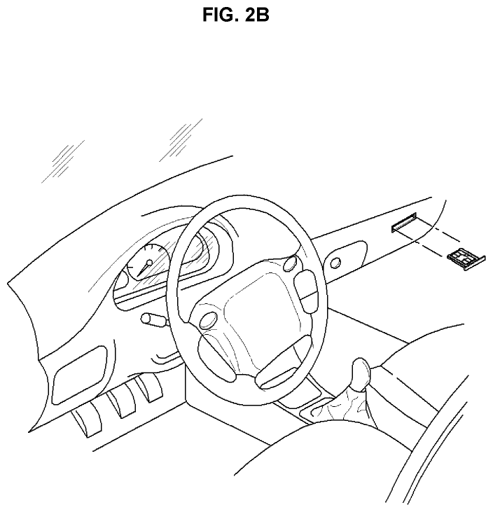

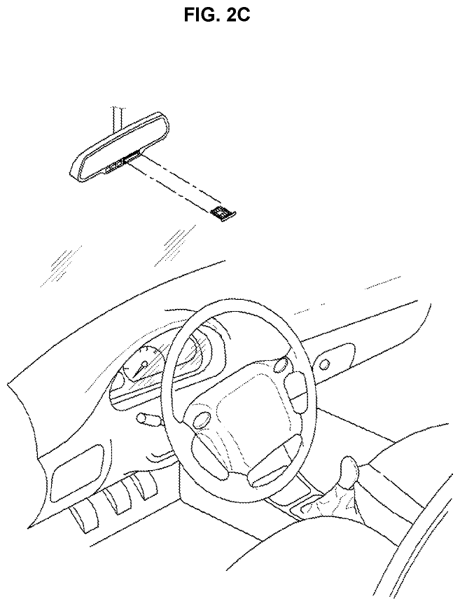

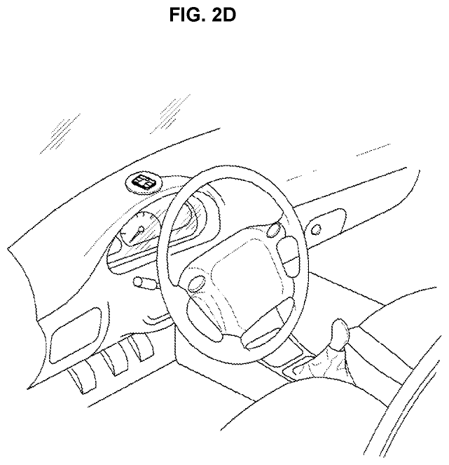

FIGS. 2A to 2D are views illustrating a method of applying an identification device to a moving object.

For example, the identification device may be a device having at least one of user identification function, a control target identification function, and service target identification function. Also, as an example, the identification device may be a device having an ID function. Also, for example, the identification device may be at least one of a smart device, a smart module, a user identification module, and an identification module. In other words, the identification device may be a hardware configuration. Also, as an example, the identification device may be used for the above-described identification in a software configuration. Herein, as an example, the identification device may be a subscriber identity module (SIM). For example, the SIM applied to the moving object as the identification device may be at least one of a Mobility SIM (M-SIM), a Vehicle SIM (V-SIM), an embedded SIM (E-SIM) or a nano SIM. In addition, as an example, the identification device may be a module that is the same as or compatible with the existing SIM, but the present disclosure is not limited thereto. The following will be described on the basis of the identification device, which may be replaced by a smart module, a user module, a SIM, and the like, but the present disclosure is not limited thereto. In the following description, the identification device is described for convenience of description. As described above, the identification device may be applied to the moving object in consideration of the case in which the moving object communicates with the external device. For example, the smart phone may recognize a smart phone user through a USIM as a universal subscriber identification module and provide a service. For example, when the same brand or identification device and the device are mutually compatible, only the identification device of the user may be changed to distinguish the user of the corresponding device, and service may be provided on the basis of the same. The moving object may also embed an identification device card on the basis of the foregoing. For example, in the identification device applied to the moving object, a vehicle SIM may be referred to as a VSIM. That is, anew type of identification device may be applied as an identification device applied to a moving object. For example, VSIM may be compatible with USIM or other SIM. In addition, the VSIM may further provide other services in consideration of moving object characteristics, but the present disclosure is not limited thereto. In addition, an identification device card applied to a moving object may be provided and may be referred to as another name, but the present disclosure is not limited thereto.

Meanwhile, as an example, referring to FIGS. 2A to 2D, there may be a part to which an identification device may be applied inside a moving object. Herein, FIGS. 2A to 2D are examples in which the identification device is applied, but the present disclosure is not limited thereto. More specifically, there may be a part to which the identification device is applied in a visually identifiable zone of the moving object's driver seat as shown in FIG. 2A. As another example, an identification device may be applied inside the storage box of the moving object's passenger seat as shown in FIG. 2B. As another example, an identification device may be inserted into a part where a display of a moving object exists, but the present disclosure is not limited thereto.

As another example, the identification device may be mounted on a mirror inside the moving object as shown in FIG. 2C. For example, the mirror inside the moving object may be easily accessed by the occupant without affecting the driving of the moving object or other devices of the moving object, and thus the identification device may be mounted on the mirror inside the moving object. As another example, the identification device may be mounted in a cradle or pad as shown in FIG. 2D. For example, when the moving object is controlled by the identification device, a plurality of cases may occur in which the identification device is replaced for each user. In view of the foregoing, the identification device may be mounted on a cradle or a pad in order to increase mounting convenience of the identification device, and may be used for controlling a moving object. Meanwhile, as an example, the cradle or pad may allow the identification device to be mounted on the basis of magnetic properties. In addition, as an example, the identification device may be mounted in the cradle or the pad on the basis of another method, but the present disclosure is not limited thereto.

As another example, the identification device may be implemented in combination with a tool key or a car key in consideration of the portability of the identification device. That is, the identification device may be mounted on the tool key or the car key, and the identification device may be detached from the car key and then mounted on the moving object. For example, the USIM or similar type of identification device may be small in size. In addition, the identification device has a part that is in contact with the moving object, in which the part in contact is needed to prevent damage. In view of the foregoing, the identification device may be coupled to a car key or a tool key. As another example, the car key or the tool key itself may be an identification device. That is, each user may own his/her own car key or tool key as an identification device, and the moving object may be controlled on the basis of the identification device. Meanwhile, as an example, when the car key or the tool key is an identification device, the car key or the tool key may be mounted on the moving object as shown in FIGS. 2A to 2D. In addition, as an example, the car key or the tool key may communicate with the moving object through short-range communication (e.g., Bluetooth, Beacon, and NFC), through which message exchange and identification may be performed. That is, the car key or the tool key that reflects the uniqueness of the individual may be used as the identification device, but the present disclosure is not limited thereto.

As another example, the above-described identification device may be mounted through an existing device mounted on a moving object. For example, the moving object may be equipped with an existing device (e.g., hi-pass terminal, black box). Herein, when a separate mounting portion is configured on the moving object to mount the identification device, the equipment for the moving object must be changed. The configuration or parts for additional mounting may be required and the existing device may be used to mount the identification device. That is, the identification device may be configured to be mounted on the existing mounted device. As another example, the identification device may be recognized through an existing terminal (e.g., USB port, cigar jack) included in the moving object.

As another example, the identification device may be applied at any position within a range that makes it possible to be authenticated by the moving object, and the identification device may be integrally or separately applied to a control unit, a communication unit, or parts of the moving object.

More specifically, the moving object may include a separate mounting unit for mounting the identification device or a component on which the identification device is mounted. That is, the identification device may be mounted on a moving object as one independent part, separately from other parts. As another example, the identification device may be mounted on a moving object to be included in at least one of a control unit, a communication unit, and another unit as described above. For example, the control unit or the communication unit in the moving object may be a unit for performing communication with an external device or controlling information. Herein, the identification device may provide necessary information to the above-described control unit and communication unit or perform operations through identification and authentication. That is, the identification device may be a device closely related to the control unit or the communication unit, and thus may be mounted on the moving object in combination with the units. That is, the identification device may be mounted on the moving object integrally with other units. As another example, the identification device may be implemented as an embedded identification device in a moving object. The embedded identification device may be physically implemented inside a moving object or may be implemented in software during a moving object operation and design process, but the present disclosure is not limited thereto. This will be described later.

For example, in order to mount an identification device, in case of changing a facility of a moving object or installing an additional configuration, the cost may be high. In consideration of the foregoing, the identification device may be mounted (or recognized) through an existing terminal included in the moving object. Through this, the identification device may be easily applied to the existing moving object, but the present disclosure is not limited thereto.

Herein, when the identification device is applied to the moving object, the moving object may perform subscriber identification on the basis of the identification device. That is, similar to a smartphone, the moving object may also identify the moving object user on the basis of the identification device. Herein, the identification device may include environment information according to the user, such as driving record information, navigation setting information, moving object setting information, driver seat information, steering information, etc. That is, by applying the identification device to the moving object, a system may be constructed on the basis of information on the use of the moving object. Also, as an example, when the identification device is not applied to the moving object, the moving object may not be operated. For example, the moving object may be operated only when the identification device is applied to be recognized However, for example, some driving may be possible in consideration of emergency situation.

Meanwhile, for example, as described above, when the identification device is not identified and authenticated to the moving object, the control authority for the moving object may not be approved. For example, when the moving object is a vehicle, the vehicle may be directly controlled by turning on the start of the vehicle. However, in the case that the identification device is applied, when the vehicle is turned on and the identification and authentication of the identification device is completed, the vehicle may be controlled. More specifically, the moving object may operate on the basis of full autonomous driving. In addition, as an example, the moving object may communicate with other devices through a communication network and operate on the basis of information received through the communication network. However, in the case of a moving object, a number of operations and functions may be defined for the purpose of movement. When identification and authentication are not guaranteed, there may be a risk of security problems and accidents. In consideration of the foregoing, the moving object may be turned on differently from the related art, and may be controlled when identification and authentication are performed on the basis of the identification device.

As another example, the identification device may operate regardless of whether the moving object is turned on. For example, the moving object may include a device for supplying power to another existing device, such as a black box. Herein, the identity device may operate by receiving power from the moving object. As another example, the identification device may provide power and operate by itself. In addition, for example, the identification device may supply power and operate based on a separate charging device such as wireless charging or solar charging. Herein, since the operation of the identification device does not consume much power, the identification device may operate regardless of whether the moving object is turned on. The identification device may operate by receiving power from the moving object or by supplying power by itself. That is, the identification device may operate regardless of whether the moving object is turned on, but the present disclosure is not limited thereto. Herein, for example, even when the moving object is not turned on, the identification device may perform identification and authentication. For example, in the case that the moving object is not turned on, the identification device may be identified and authenticated when the vehicle owner's personal device is recognized to be triggered As another example, even when the moving object is not turned on, when the driver or another user is in the moving object, the identification and authentication operation for the identification device may be performed, but the present disclosure is not limited thereto. That is, the identification device may operate even when the moving object is not turned on, but the present disclosure is not limited thereto.

Herein, as an example, the moving object may be prevented from being arbitrarily removed from the moving object in consideration of the foregoing. More specifically, as described above, the risk for security and accidents may be large in the case of a moving object. In addition, as described above, in the case of operation based on the identification device, an accident risk may occur on the basis of an authentication error when the identification device is arbitrarily detached. In view of the foregoing, the identification device may be prevented from being arbitrarily detached. For example, the identification device may be arbitrarily attached and detached before the moving object is turned on. That is, when the moving object does not operate, the detachment of the identification device may not be locked. Therefore, the user who wants to use the moving object may replace the identification device and use the identification device suitable for the user before the moving object is turned on.

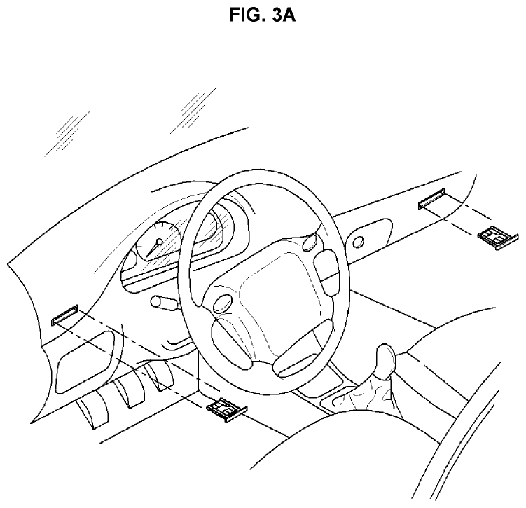

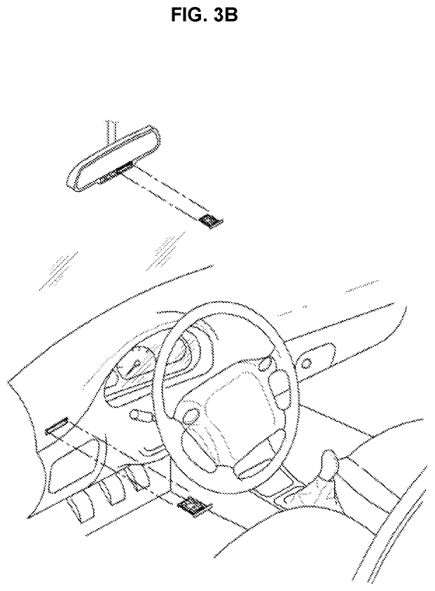

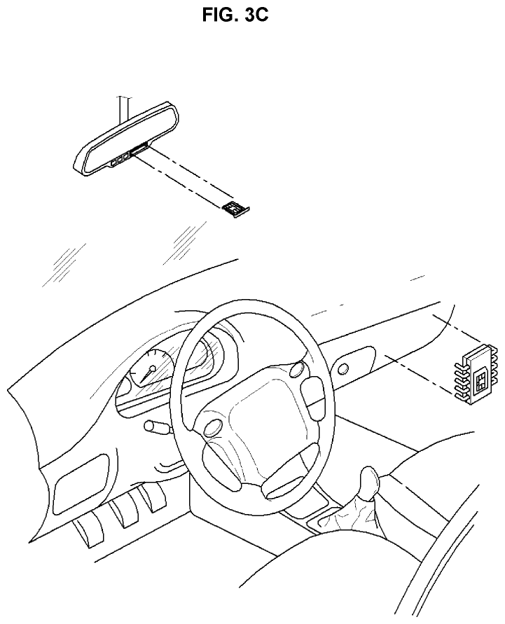

In addition, for example, referring to FIGS. 3A to 3C, a plurality of identification devices may be installed in the moving object. For example, referring to FIGS. 3A and 3B, the plurality of identification devices may be installed in the moving object based on respective positions. Herein, for example, the positions at which the plurality of identification devices is installed may be variously set, and the installation positions are not limited to FIGS. 3A and 3B. That is, the plurality of identification devices may be installed in the moving object to perform individual identification and authentication, which will be described below.

In addition, for example, as shown in FIG. 3C, some of the plurality of identification devices may be embedded and the other identification devices may be installed. Herein, the embedded identification device is implemented physically or in software in the moving object. For example, the embedded identification device may be the above-described E-SIM. That is, the embedded identification device may include an identification device implemented inside the moving object, but the present disclosure is not limited thereto. When the plurality of identification devices is applied to the moving object, the identification device may be installed or implemented in the moving object in various ways, but the present disclosure is not limited thereto.

For example, each identification device may perform identification and authentication respectively for each user. Herein, for example, each identification device may correspond to at least one of user. More specifically, the moving object may be used by a plurality of users unlike the existing smart devices. Herein, since the moving object includes autonomous driving or user-specific functions, the moving object need to be used by identifying each user. In view of the foregoing, the plurality of identification devices may be installed (or implemented) in the moving object. Therefore, the moving object may recognize a plurality of users using the plurality of identification devices.

As another example, as described above, an autonomous driving function or a user-specific function may be set in the moving object. For example, the plurality of users may have different preferred moving object settings. In addition, the plurality of users may use the moving object in different environments. Herein, in consideration of this, it is necessary to manually change settings in the current moving object. In addition, for example, the autonomous driving function may be set differently for each user. For example, autonomous driving mode may be set to a full autonomous mode or a partial autonomous driving mode based on the skill of the user. In addition, for example, the autonomous driving mode may be set differently based on the age or driving experience of the user. That is, the autonomous driving mode may be set differently for each user who uses the moving object, but the present disclosure is not limited thereto.

As described above, when a plurality of users uses the moving object, the moving object needs to be used distinguishably for each user and, herein, may include plurality of identification devices which may correspond to a plurality of users.

For example, when the moving object is used, the moving object may perform identification and authentication with respect to the user and operate based on the identification device of the user. Herein, for example, the user may be identified and authenticated using a camera included in the moving object. As another example, the user may be identified and authenticated based on fingerprint identification information or a separate authentication key. That is, each user may register their fingerprint information or may be assigned a separate authentication key (e.g., a password) and then may be identified and authenticated using the fingerprint information or the separate authentication key when using the moving object. As another example, identification and authentication of the user may be performed using at least one of fingerprint recognition, iris recognition, facial recognition, moving object head unit input, FOB key, electronic key, Internet pre-booking, another device, a server, and a mobile device. That is, the moving object may identify and authenticate each user, but the present disclosure is not limited thereto. In addition, for example, when the identification device is installed, the moving object may identify and authenticate a user based on information stored in the identification device. That is, when the identification device is installed without additional identification and authentication, the moving object may identify and authenticate a user corresponding to the identification device and operate based on this.

Herein, as another example, operation of installing an identification device may be restricted in order to prevent an unauthorized identification device from being installed in the moving object without permission. More specifically, the moving object may perform authentication based on wireless communication with the identification device or the device of the user who uses the identification device. That is, authentication for allowing installation of the identification device may be performed before the identification device is installed, thereby preventing the identification device from being installed without permission. For example, the identification device installation unit of the moving object may not be opened until authentication and may be opened when installation is allowed through pre-authentication using the identification device itself or the device of the user. Herein, the moving object may identify and authenticate the user by only installing the identification device, and operate based on this, but the present disclosure is not limited thereto.

Herein, when the moving object identifies and authenticates the user, the moving object may operate based on the identification device corresponding to the identified and authenticated user. For example, the moving object may store and update information on use or driving of the moving object in the identification device based on the user. In addition, for example, setting information for the user may be stored in the identification device. Herein, when the moving object recognizes the user, the setting of the moving object may be changed based on the setting information included in the identification device.

Herein, for example, when the moving object is turned on, arbitrary detachment of an identification device may be prohibited. That is, detachment of an identification device may be locked. Therefore, it is possible to prevent accidents due to detachment of the identification device while the moving object travels. Herein, for example, even when the moving object is turned on, locking of detachment may vary depending on whether the moving object travels. For example, even when the moving object is turned on, if the moving object does not travel, detachment of the identification device is possible after a separate device is authenticated. For example, the separate device may be a smart device. Herein, a user may perform authentication for detachment of the identification device via the smart device, provide information thereon to the moving object, and acquire authority to detach the identification device. Thereafter, detachment of the identification device is unlocked, and, when the identification device is detached from the moving object, the moving object may be turned off. Thereafter, when another identification device is installed, operation may be performed on the installed identification device. In contrast, when the moving object is turned on and the moving object is traveling, even if another device is authenticated, detachment of the identification device may be impossible. For example, when the moving object is traveling the moving object may travel by exchanging information with an external device via autonomous driving or communication. Accidents may occur when the identification device is arbitrarily detached. Therefore, arbitrary detachment may be prevented for preventing such accidents.

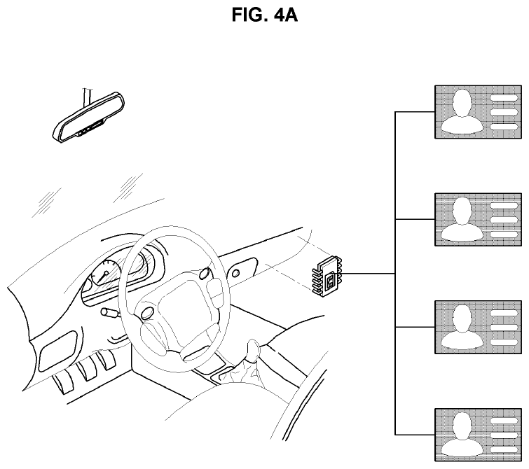

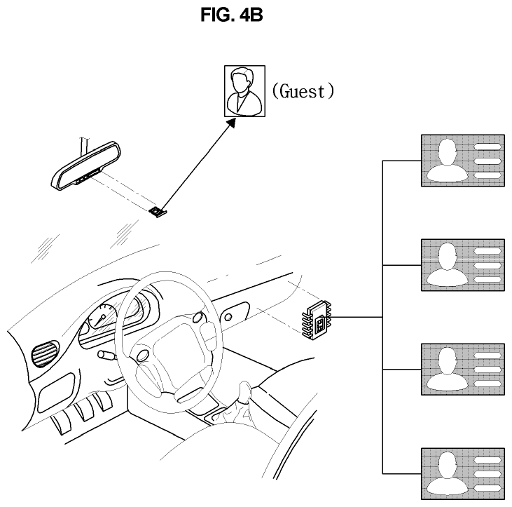

FIGS. 4A and 4B are views illustrating the case where a plurality of users uses a moving object using one SIM, according to an embodiment of the present disclosure.

Generally, a device user and an identification device (e.g., USIM) correspond one-to-one in the smart device (e.g., smart phone). For example, the user may not need to change the identification device except for reasons such as traveling abroad or smartphone damage. However, as an example, a moving object may be used by many users. For example, in the case of a vehicle, a case may be considered in which the vehicle may be driven by not only the vehicle owner but also a family member or acquaintance.

In view of the foregoing, a plurality of users may be registered or authenticated in one identification device. For example, a plurality of users (e.g., a vehicle owner and a vehicle owner family member, a vehicle owner and a vehicle sharing group, a company owning a vehicle and a vehicle sharing group, etc.) may be registered in one identification device. Herein, for example, used services or information may differ between users. In consideration of the foregoing, a plurality of users 411a to 414a may be registered in an identification device 400a, as shown in FIG. 4A.

Herein, in the present disclosure, information on a preset user may be included in an identification device at the time of initial vehicle registration. Herein, the preset user may include one user or one or more users. In the present disclosure, the preset user may correspond to a user who has previously acquired a right to use the moving object at the time of initial setting of the moving object. For example, the preset user may correspond to a vehicle purchaser or persons specified as persons who will share the moving object by the vehicle owner at the time of purchasing the moving object. More specifically, when the moving object is purchased, the moving object purchaser may set family member as the preset user in addition to the moving object purchaser, and the preset user may mean one or more users who are set to use the moving object at the time of initial registration of the vehicle, without being limited to the above-described example.

Herein, an additional user may be added, in addition to the preset user. For example, in this case, the additional user may be added only when additional authentication is completed by authentication of a server (authority). The reason why additional authentication is performed with respect to the additional user is to acquire a right to use the moving object and enable the server to determine whether there is a right to use the moving object. According to an embodiment of the present disclosure, a detailed description of the method for adding the additional user will be described in detail below with reference to FIG. 6.

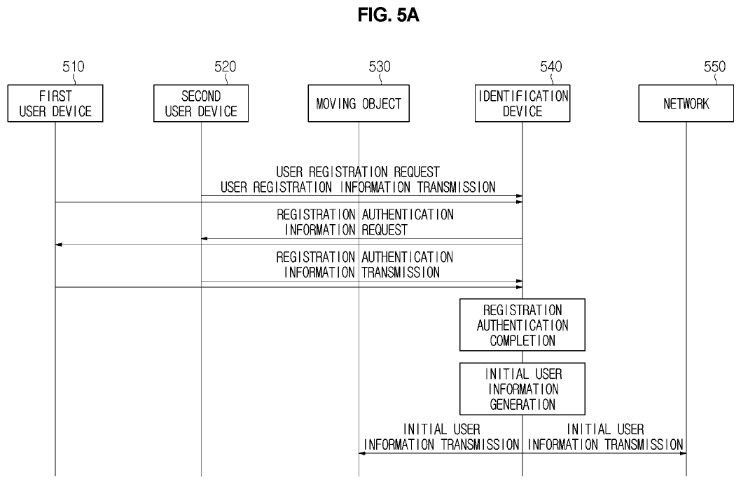

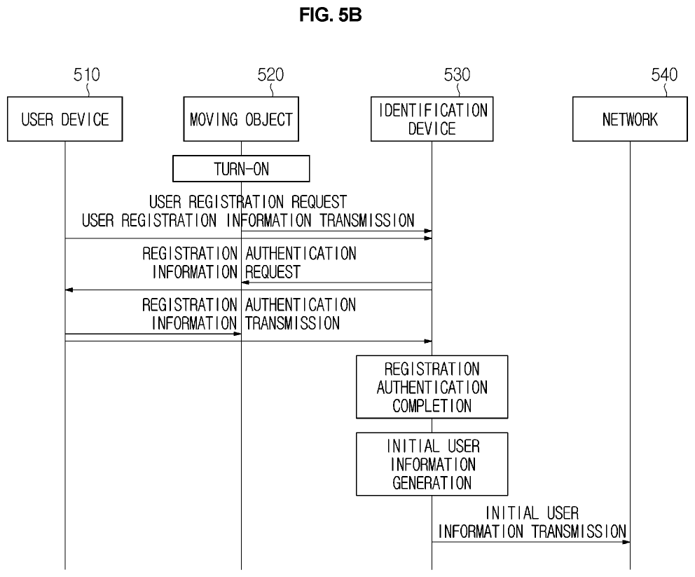

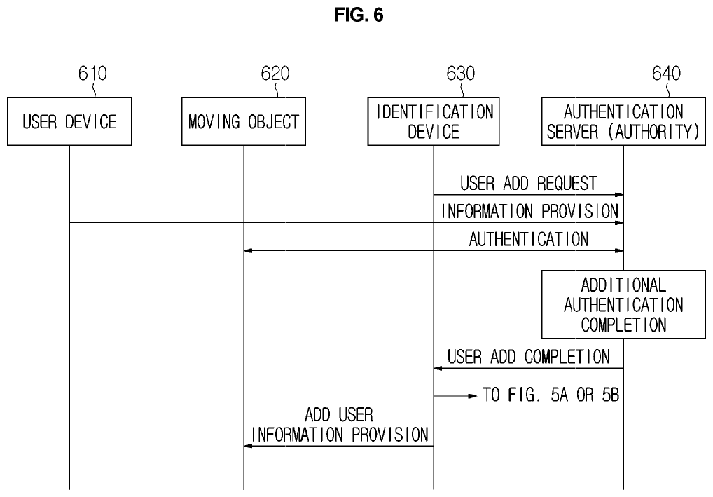

Herein, the preset user or additional user who is additionally authenticated need to perform an initial authentication process. The identification device may determine whether registration and authentication are performed, by performing the initial authentication process with respect to a user who has requested authentication (registration). The identification device may generate initial user information with respect to a user who has completed registration and authentication. In an embodiment of the present disclosure, a detailed description of the initial authentication step of registering the user will be described in detail below with reference to FIGS. 5A and 5B.

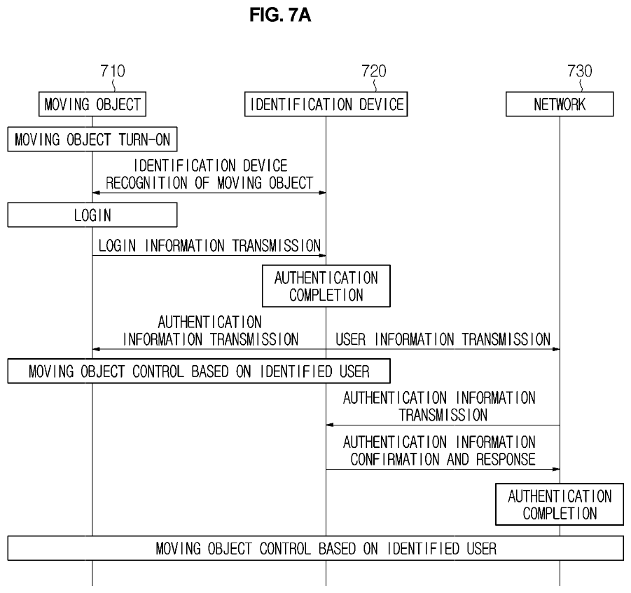

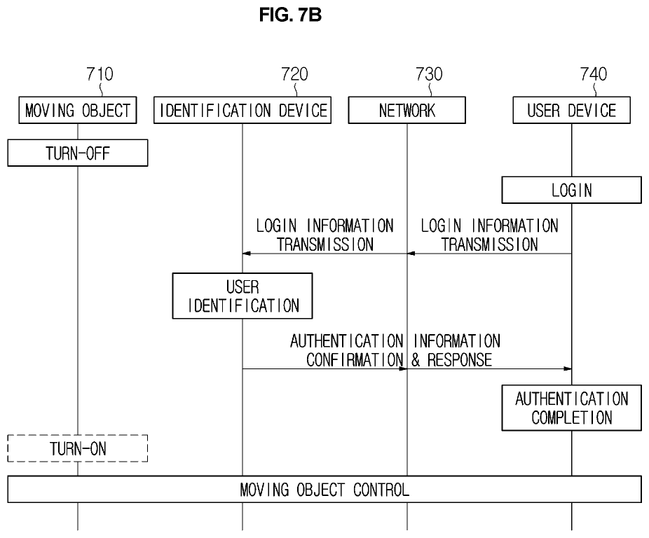

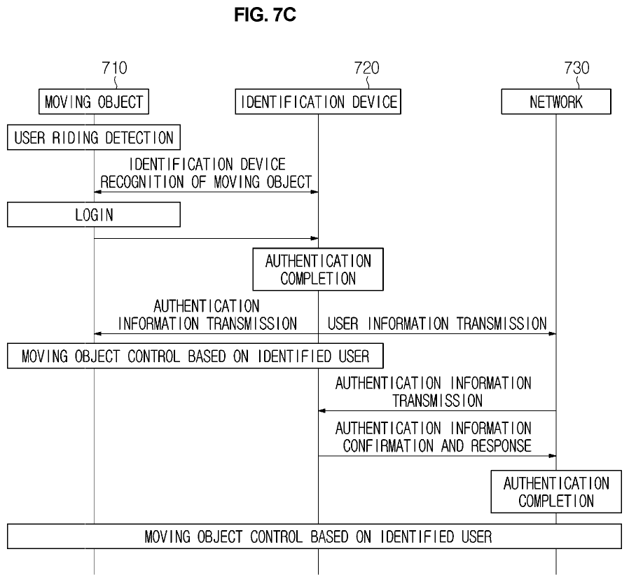

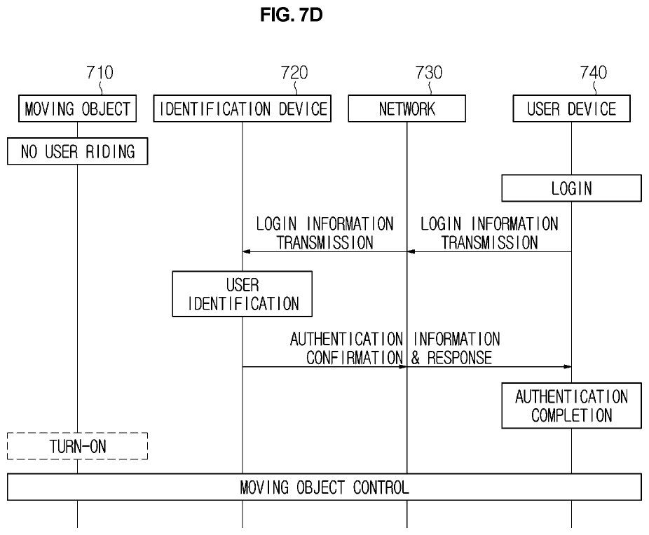

Thereafter, the user may access the identification device via a login process and moving object control information of each user may be updated based on information generated when the user uses the moving object. Herein, whether each user has been registered may be determined via the login process and a user who has logged in among a plurality of users may be identified from among registered users. In addition, the moving object may be controlled based on the identified user only when the identification device has completed authentication. A method of performing authentication at an identification device based on login of a user and controlling a moving object based on the identified user according to an embodiment will be described in detail below with reference to FIGS. 7A to 7D.

Herein, in the present disclosure, the identification device may be an attachable/detachable device. However, the identification device may correspond to an identification device embedded in a moving object and a plurality of user services may be implemented using one SIM.

That is, according to an embodiment of the present disclosure, as an identification device in which a plurality of users is registered and authenticated, an embedded identification device (or an embedded SIM or an E-SIM) is applicable to a moving object. Herein, the E-SIM may mean a digital SIM installed in the moving object, not a physical card like a USIM. For example, the E-SIM may include a SIM encrypting authentication information included in the SIM and installing the encrypted authentication information inside the moving object. That is, the E-SIM may be implemented inside the moving object in hardware or software. Herein, for example, the information included in the E-SIM of the moving object may be modified based on remote control or other communication. That is, in the case of the moving object, there may be an owner and it is necessary to implement authentication information based on the owner. Herein, since the owner of the moving object may not be easily changed, user identification information may be implemented via an E-SIM and the moving object may be controlled based on authentication. Herein, for example, when the E-SIM is applied to the moving object, authentication may be performed based on an authentication system in the moving object (or mobility). As another example, authentication of the E-SIM installed in the moving object may be performed based on a mobile device. For example, the mobile device may include a smart device, a head unit, etc. That is, authentication of the E-SIM installed in the moving object may be performed based on a separate mobile device.

As another example, the E-SIM embedded in the moving object may be authenticated based on communication with the server. For example, the smart device may recognize the SIM through communication with a base station. The E-SIM of the moving object may perform authentication based on communication between the E-SIM and the server in a similar manner and operate based thereon.

As another example, the E-SIM embedded in the moving object may be authenticated based on a D2D method or an M2M method. For example, the owner or driver of the moving object may have a mobile device when driving the moving object. In addition, for example, the mobile device in the moving object may be used. Herein, authentication of the E-SIM embedded in the moving object may be performed based on the mobile device located at an adjacent distance and a D2D method. For example, the above-described authentication method may be performed in consideration of security of the moving object.

As another example, since the E-SIM is not physically installed, the E-SIM may not be detached or removed. However, a general identification device may be detached from the moving object in consideration of the case where the moving object is stolen or the other situations. Herein, for example, a system for preventing the moving object from being stolen or the SIM from being forcibly detached may be necessary. For example, in the case where the identification device is applied to the moving object, additional authentication of another mobile device may be necessary when the identification device is detached. That is, the identification device may be detached after authentication and confirmation based on another device mutually authenticated with the identification device of the moving object. As another example, the identification device may be detached through personal authentication. For example, authentication may be performed based on unique characteristics of a user, such as fingerprint recognition, iris recognition or facial recognition and the identification device may be detached only by the authenticated user. In addition, for example, detachment of the identification device may be performed only when necessary information is authenticated based on artificial intelligence. For example, the identification device may be detached only by the user authenticated based on recognition information such as the image or voice of the user. In addition, the identification device may be detached depending on whether the moving object is turned on or whether the moving object is traveling or may be detached based on authentication regardless of whether the moving object is turned on or whether the moving object is traveling, but the present disclosure is not limited thereto.

In addition, according to another embodiment of the present disclosure, a guest user may use the moving object. Referring to FIG. 4B, an embodiment in which a guest user 430b who is not registered uses the moving object is shown. Herein, an unregistered user of FIG. 4B, that is, the guest user 430b of the moving object, may mean a user who does not perform an user authentication procedure with respect to an authentication authority or server, and, for example, mean a user other than the registered user, such as a user who is not a family member of the moving object, a user who uses the moving object temporarily or in a short term or a user who needs to use the moving object in a specific situation.

In this case, in order to operate the moving object of the present disclosure, the guest user 430b may control the moving object through another identification device 420b without performing additional authentication through the server (authority) as shown in FIG. 6. Herein, for some reasons such as security of the identification device, an identification device 420b different from the embedded identification device may be used. Herein, for example, the identification device 420b of FIG. 4B may correspond to an identification device which may be attached to or detached from the moving object. Herein, when the guest user uses the identification device 420b, the function of the identification device may be limited. For example, when personal information of the guest user may not be generated or registration of the guest user may not be necessary and the moving object may not be controlled according to information on the guest user.

In addition, in an example, the identification device 420b for the guest user may be provided inside the moving object, may not be easily attached/detached by setting a password for some reasons such as security, and may not be easily detached from the moving object.

FIGS. 5A and 5B are flowcharts illustrating an initial authentication process of a preset user, according to an embodiment of the present disclosure.

When a plurality of users uses one identification device, an initial authentication step of registering preset users or added users may be performed. Herein, initial authentication of the user may be performed with respect to each user and needs to be performed once when the identification device is first used. Thereafter, information on the user may be updated based on the generated authentication or registration information.

Authentication or registration of the user may be performed using a user device or a moving object. Herein, the user device may mean a device supporting a communication function and possessed by the user except for the moving object. Herein, the user device may comprise a smartphone, a smart watch, a tablet PC, etc. and include all devices capable of performing communication with the identification device, but the present disclosure is not limited thereto.

Herein, when initial user authentication is performed using the user device, the identification device may receive user registration information which is the unique information of the user who has requested registration and is identified from another user. The identification device may generate initial user information from the received user registration information and store the initial user information. In addition, the initial user information may be transmitted via a network.

Herein, for example, when identification device generates the initial user information, the identification device may generate identification information such as an ID and an identification number with respect to each of the plurality of users. In addition, the identification device may update information based on the generated identification information. That is, identification information of each user may be included in the initial user information. When the user logs in to the identification device later, the user may retrieve the identification information allocated thereto. In addition, the update information of the user, which is generated when the user who has logged in uses the moving object, may be classified and stored based on identification information. Accordingly, the identification device may generate and manage the information of each user based on the initial user information of the user.

Herein, the user registration information may correspond to unique information of the user. The user registration information includes at least one of an identification number indicating a user, a name of user, a user age, a relationship with a main user, etc., as the user registration information is identified from another user. Herein, the user registration information may include user login information.

Herein, in the present disclosure, the user login information may mean information for enabling a user identified from another user to access this identification device. Herein, the user login information may comprise a user ID, a password corresponding to the user ID, the iris information of the user, the fingerprint information of the user, information generated by the photo and image of the user, etc., brainwave information received from a brain-computer interface (BCI), but the present disclosure is not limited thereto.

Herein, FIG. 5A is a view illustrating a method of performing authentication in an identification device using a user device when there is a plurality of users. Herein, first user device 510 and second user device 520 of FIG. 5A may correspond to devices of different users.

As shown in FIG. 5A, when different users perform initial authentication for user registration using the respective user devices (first user device and second user device) 510 and 520, the users may request user registration using the respective user devices thereof. Herein, for description of the present disclosure, assume that the device of the user who has requested user registration is the first user device 510. In addition, when the first user device 510 requests user registration, the above-described user registration information may be transmitted to the identification device 540.

The identification device 540 receiving the user registration request may request registration authentication information to the first user device 510. This procedure is processed in order that the identification device 540 determines whether the user requesting additional registration have rights to control the moving object 530. Herein, the registration authentication information may comprise information capable of being recognized an authorized user, such as the owner of the moving object, the main user of the moving object, an initial registrant, etc.

Herein, according to an example, when the identification device 540 receives the request for the registration authentication information from the first user device 510, an authentication number may be transmitted to the device of the owner of the moving object 530, and a user who wants to be additionally registered may input the authentication number to the first user device 510. In addition, according to an example, the identification device 540 may perform registration and authentication based on login information of the owner of the moving object 530. In addition, the identification device 540 may receive a unique number of the identification device 540 previously assigned to the owner of the moving object and perform registration and authentication, but the present disclosure is not limited thereto. Thereafter, the identification device 540 may generate initial user information based on the received user registration information.

In addition, the identification device 540 may transmit the initial user information to the network 550. Herein, as the initial user information is generated based on the user registration information, the initial user information may include user login information and unique information of the user according to an example, but the present disclosure is not limited thereto.

In addition, as another example, user registration may be performed using the moving object as well as the user device. In this case, the moving object may receive the user registration information which is the unique information of the user and transmit the information to the identification device, thereby performing user registration. For example, when the moving object includes a camera, the moving object may transmit, to the identification device, user registration information generated by recognizing the user located on the driver's seat of the moving object. As another example, the moving object may perform registration by recognizing the fingerprint information of the user or receiving an authentication key. In addition, user registration may correspond to information received from at least one of fingerprint recognition, iris recognition or facial recognition, moving object head unit input, FOB key, Internet advance reservation, other devices, servers and mobile devices. As another example, registration may be performed based on recognition information of the image, voice, etc. of the user. An embodiment of the above-described user registration information may correspond to the user login information, which may correspond to an embodiment corresponding to a user authentication method. In addition, the user registration and authentication method of the present disclosure is not limited to the above-described embodiments. The above-described embodiments will be described using a flowchart for requesting initial authentication or user registration using the first user device 510 and the moving object as shown in FIG. 5A.

When the moving object is turned on, as shown in FIG. 5B, the moving object 570 may request user registration from the identification device 580, in addition to the user device 560. Herein, since the moving object 570 is turned on, the moving object 570 may generate and transmit the user registration information to the identification device 580. That is, when the user device 560 or the moving object 570 requests user registration, the above-described user registration information may be transmitted to the identification device 580. Thereafter, the identification device 580 may request registration authentication information from the user device 560 or the moving object 570 according to the method described above with reference to FIG. 5A. A user who wants to be registered may input registration authentication information to the user device 560 or the moving object 570 and transmit the registration authentication information. Thereafter, the identification device 580 may generate initial user information based on the received user registration information.

FIG. 6 is a flowchart illustrating the case where a user is added in addition to the preset users, according to an embodiment of the present disclosure. In this case, according to an example of the present disclosure, a new user may be added to the identification device 630, in addition to users set when the moving object 620 is purchased or registered uses who currently use the identification device 630, and additional authentication from the server (authority) 640 may be performed to add the new user.

Herein, a user add request may be processed using the identification device 630. More specifically, since the user add request may be operation of adding anew user in the server (authority) 640, the user add request may be processed using an authenticated identification device 630. Herein, since the identification device 630 may be authenticated and secured, in a relationship with the server (authority) 640, a request received from identification device 630 may be reliable. For example, the server (authority) 640 may receive a user add request message from the identification device 630. Herein, the server (authority) 640 may confirm that the user needs to be added to the moving object based on the user add request message. In addition, the server (authority) 640 may receive information on the user who needs to be added from the user device 610. That is, the server (authority) 640 may confirm information on addition of the user through the identification device 630 and acquire the information on the actually added user from the user device 610. Thereafter, the server (authority) 640 may perform the authentication procedure with the moving object 620 based on the received information. Herein, when the authentication procedure of the moving object 620 and the server (authority) 640 is completed, the server (authority) 640 may transmit a user add completion message to the identification device 630. That is, the server (authority) 640 may perform authentication with the moving object 620 based on the received information and transmit information for adding the user to the identification device 630 based on authentication. Thereafter, the identification device 630 may perform a user registration procedure based on FIG. 5A or 5B, as described above. The identification device 630 may apply the information on the additional user to the moving object 620, but the present disclosure is not limited thereto.

For example, the server 640 may correspond to a server of an organ or a company which sells the moving object 620, but the present disclosure is not limited thereto.

FIGS. 7A to 7D are flowcharts illustrating a process for login authentication of identification device and for control of a moving object, according to an embodiment of the present disclosure. Herein, when a registered user logs in to the identification device, the identification device may perform login authentication. Herein, only when the login authentication of the registered user is completed according to FIGS. 5A and 5B, the moving object may be controlled based on the identified user. That is, in the case where a plurality of users uses the identification device, a login procedure may be performed, such that information on each user or moving object control information generated for each user is accessed and the moving object is controlled based on the identified user.

For example, in order to perform authentication for identifying the user who logs in, the identification device may perform authentication based on login information. Herein, the login procedure performed in FIGS. 7A to 7D may be performed using a moving object or a device owned by the user. Herein, the login procedure refers to a procedure for determining whether the user has been registered and identifying the logged-in user from the other registered users, and may correspond to a process of inputting personal information of the logged-in user distinguished from the other users. Herein, according to an example, the login information of the user may correspond to information included in registration information of the user described in FIGS. 5A and 5B or information generated from the registration information of the user.

FIG. 7A is a flowchart illustrating process for authentication of identification device based on login information received from a moving object, when the moving object is turned on.

When the moving object 710 is turned on, the moving object 710 may first recognize an identification device 720. The moving object 710 may transmit login information through a login procedure. Herein, the login procedure may be performed based on the login information of the user. Herein, the login information of the user used to perform the authentication procedure for login may include the iris and fingerprint of the user who rides in the moving object, a user ID and password, voice, a picture, an image, etc., but the present disclosure is not limited thereto.

Meanwhile, as another example, when the moving object is used, as described above, authentication of the user may be performed using another method. For example, when the moving object is turned on and identification and authentication of the identification device are completed, the moving object may acquire additional authentication information. For example, the moving object may include a camera, recognize a user located on the driver's seat of the moving object, and identify a specific user among the users registered in the identification device based on the recognized user. As another example, fingerprint recognition or a separate authentication key may be used. That is, when the moving object is turned on and identification and authentication of the identification device are completed, each user may register their fingerprint or may be assigned a separate authentication key (e.g., a password) and then may be identified and authenticated through the fingerprint or the separate authentication key. In addition, for example, separate authentication may include at least one of fingerprint recognition, iris recognition, facial recognition, moving object head unit input, FOB key, Internet advance reservation, another device, a server, and a mobile device. That is, separate authentication may be necessary, the present disclosure is not limited to the separate authentication method according to the above-described embodiment. Herein, for example, separate authentication may be performed based on the unique features of the user. As another example, authentication may be performed based on recognition information of the image or voice of the user, without being limited thereto. As a detailed example, in the case of a smart device, the user of the smart device may always carry the device. However, the moving object may be used periodically or based on an event. Herein, for example, there may be a limitation in completing identification and authentication only with the identification device in consideration of above-described charging or setting information on the use of the moving object. Therefore, as described above, after the identification device completes identification and authentication, the moving object may be operated or controlled after completing the further authentication on the basis of the above-described method of detecting the user.

The login information input to the moving object 710 may be transmitted to the identification device 720. Thereafter, the identification device 720 may determine whether the user corresponding to the login information is authenticated based on information on a previously registered user. That is, the identification device 720 may perform identification and authentication for the current user. More specifically, the identification device 720 may identify a logged-in user from a plurality of registered users. When the identification device 720 has completed authentication, the identification device 720 may transmit authentication information to the moving object 710. Herein, the identification device 720 may load information (moving object control information) based on the logged-in user and set the moving object based on the identified user. In addition, in this case, an authentication procedure for log in using the user device may be performed.

In addition, FIG. 7B is a flowchart illustrating process for receiving user identification from an identification device using a user device when the moving object is turned off. In this case, this may correspond to the case where login is perform with respect to a turned-off vehicle and settings of the vehicle are changed based on information on the logged-in user based on the vehicle is turned on.

In this case, a user authentication procedure may be performed using a user device 740 which is an electronic device possessed by the user and capable of performing communication and the identification device 720. First, the user device 740 may perform a login procedure and receive login information from the user. The login information may be transmitted to the identification device 720 embedded in the moving object 710 via a network 730. Based on the received login information, the identification device 720 may identify the logged-in user. When the logged-in user is identified and authentication succeeds, the identification device 720 may transmit a confirmation and response message for authentication information to the user device 740.

When authentication is completed, the identification device 720 may transmit status information of the moving object corresponding to the common information of the moving object to the user device 740. In this case, the common information of the moving object may be updated at a predetermined reception interval. Herein, for example, the identification device 720 may receive the common information of the moving object from the moving object 710 at a predetermined time interval and update information. Therefore, the user may confirm the status information of the moving object 710 through the user device 740.

In addition, for example, the identification device 720 may tum on the moving object 710 based on user-specific information of the logged-in user. Herein, the user-specific information may be stored in the identification device 720, and, for example, may correspond to information stored in the network. Accordingly, the user may access the identification device 720 using the user device 740 before riding in the moving object 710 and change settings of the moving object 710. In addition, for example, the identification device 720 may transmit the user-specific information of the logged-in user to the user device 740. Herein, the user device 740 may receive the user-specific user as the information received from the user and modified information. Thereafter, the user device 740 may transmit the modified user-specific information to the identification device 720 and update the user-specific information.

FIG. 7C according to another embodiment is a flowchart illustrating an authentication procedure which may be performed upon determining that a user has ridden in a moving object as a result of detecting whether the user has ridden in the moving object. Upon determining that the user has ridden in, as shown in FIG. 7A, login may be performed using the moving object or the user device, and the identification device may perform the authentication procedure. Herein, for example, after determining whether the user has ridden in the moving object, a procedure performed after the moving object and the identification device perform mutual authentication may be the same as FIG. 7A.

In addition, FIG. 7D according to another embodiment is a flowchart illustrating an authentication procedure which may be performed upon determining that a user does not ride in a moving object as a result of detecting whether the user has ridden in the moving object. Upon determining that the user does not ride in the moving object, as shown in FIG. 7B, login may be performed using the user device and the identification device may perform the authentication procedure. That is, this case may correspond to the case where the settings of the moving object are changed according to the logged-in user before the user rides in the moving object and then the moving object is turned on.

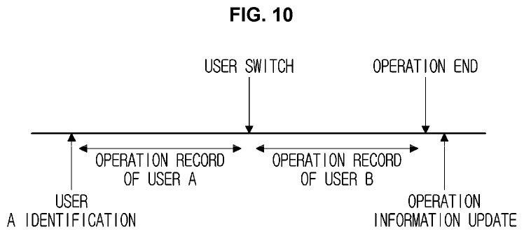

In addition, as another embodiment, the moving object may detect whether a user using the moving object has left the moving object (whether or not riding has ended, or whether or not the user has got off). Herein, upon determining that the user does not ride in the moving object, the identification device may perform a user logout procedure to lock the moving object. Here, lock may mean a procedure for turning off the moving object or a state in which the moving object stands by for a next user. The state in which the moving object stands by may mean that the moving object is not used and is in a standby state. As a more specific example, the state in which the moving object stands by may mean a period of time from a time when use of the moving object ends to a time when a next user who shares the moving object uses the moving object, when a plurality of users uses a shared moving object. In addition, when riding of the user ends, the identification device may update moving object control information. Storage and management of the moving object control information according to end of riding will be described in greater detail with reference to FIG. 10.

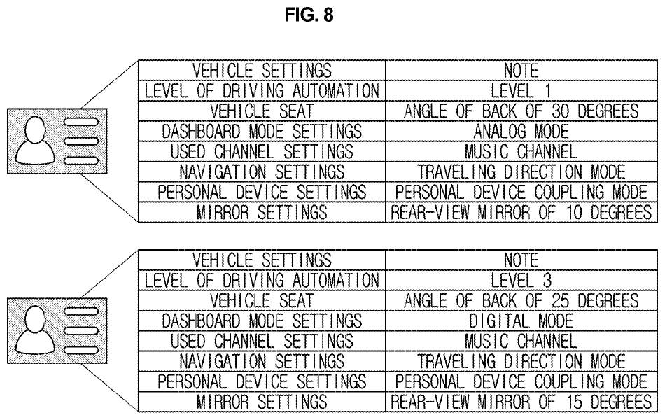

FIG. 8 is a view illustrating moving object control information stored and managed in an identification device, according to an embodiment of the present disclosure.

The above-described identification device may store each user information. More specifically, the service for the moving object may be diversified. For example, although a vehicle is currently used for traveling as a moving object, users may not be distinguished. Services provided to the users by the moving object are increasing and settings or information considering personal preferences or personal characteristics may be necessary. In consideration of this, the identification device may store information on or settings of a specific user and apply the information or settings to each moving object. That is, the identification device may perform a control device function for increasing convenience of use of moving object in addition to authentication.

Herein, in the present disclosure, information for controlling the moving object may be referred to as moving object control information. In addition, the moving object control information may correspond to information stored in and managed by the identification device, and the moving object control information may correspond to information stored and managed for each user in the present disclosure. As an example of the present disclosure, as shown in FIG. 8, the information stored in and managed by the identification device for each user may include vehicle settings, an autonomous traveling level, a vehicle seat, dashboard mode settings, dashboard mode settings, used channel settings, navigation settings, personal device settings, mirror settings, etc., without being limited thereto.

In addition, as another example, the moving object control information may be managed to distinguish between moving object common information and user-specific information. That is, even when a plurality of users is registered in one identification device, the information may be managed to be classified into user-specific information necessary for each registered user and common information commonly applicable to all registered users.

Herein, in the present disclosure, the common information may correspond to common information considering moving object identification even when a plurality of users is registered in one identification device 820. Herein, since it is unnecessary to distinguish each user with respect to the common information, the identification device may autonomously manage this. For example, vehicle status information may not differ between users and thus may be common information.

In addition, in the present disclosure, the user-specific information may be information updated and applied while the identified user uses the moving object and may correspond to information reflecting the characteristics and preferences of each user. In addition, the user-specific information may be generated for each user. As a non-limiting example, navigation settings or vehicle seat settings may differ between users and thus may be user-specific information. The user-specific information may include user information, moving object setting information and moving object related information according to the embodiment. As another example, the user-specific information may include autonomous driving level information, vehicle seat, dashboard mode settings, used channel settings, navigation settings, personal device settings, mirror settings, etc. As another example, the user-specific information may include information on the driving type set in the personal device of the user in various driving environments, such as the position and height of a driver's seat, the color and brightness of interior lightings, the positions and angles of the room and side-view mirrors, an inside temperature control (air conditioner and heater) range, the angle of a steering wheel, tire pressure, the transmission setting mode (normal, eco, power mode, etc.), the wireless communication connection mode (WAVE, cellular, etc.), an autonomous driving function setting variable range (speed and vehicle interval, transverse speed for lane change, acceleration and deceleration, etc.), or a widget function. In addition, for example, the user-specific information may include a dashboard mode, navigation settings and content settings. In addition, the user-specific information may include a variety of information in addition to the above-described information, but the present disclosure is not limited thereto. That is, the user setting information may be included in the identification device, such that a customized service is provided to a user who uses the moving object and the moving object is controlled in consideration of the user.

The identification device may distinguishably manage, store, update and use the common information and the user-specific information. More specifically, the user-specific information and the moving object common information may be updated and added while the user uses the moving object. Herein, for example, for the navigation settings or the vehicle seat settings corresponding to the user-specific information, information on the logged-in user may be continuously added and updated while the user uses the moving object. For example, information on a destination which is frequently used by the current user, a navigation display mode, a volume setting mode, etc. may be updated as the user-specific information.

As an embodiment, to which the above description is applied, in FIG. 7A, the identification device 720 may load the user-specific information of the current authenticated user and the moving object 710 may be controlled based on the identified user. Herein, for example, the navigation settings, the vehicle seat, and the dashboard mode settings of the moving object 710 may be changed based on the user-specific information of the identified user.

In addition, the identification device 720 may load the common information of the moving object after completing authentication of the current user and may control the moving object 710. In addition, as another example, since the common information of the moving object may not vary according to the user, after the moving object 710 recognizes the identification device 720, the identification device 720 may load the common information without authentication of the user, thereby controlling the moving object 710.

In addition, as a detailed example, various services may be provided through the identification device of the moving object. For example, a moving object operation record may be stored through the identification device of the moving object. In addition, it is possible to check the moving object operation record for each individual and utilize the moving object operation record through a server or a system.

More specifically, existing moving object driving information and related information may be stored and shared based on the moving object. Herein, when the identification device is applied to the moving object, the user may be identified through the identification device and moving object driving information and related information may be stored and used for each user. For example, the moving object driving information may include at least one of visited area information, driving distance information, driving pattern information or driving route information. In addition, the moving object driving information may be used based on the user of the identification device in relation to the moving object, but the present disclosure is not limited thereto. Herein, the user may store and use the moving object driving information related thereto based on the identification device and thus utilize related disclosure even when the moving object is changed. For example, the user may use a service through autonomous driving or intelligent transportation systems (ITS) infrastructure based on the information stored in the identification device. For example, the user may receive a service such as an autonomous driving level, surrounding restaurant information and a travel route in relation to a driving pattern thereof. Herein, as described above, the information may be managed through the identification device.

In addition, the moving object may perform communication with another device through the identification device. For example, another device may include smart devices, IoT-based peripherals, communicable home appliances or apparatuses such as roadside unit (RSU) or ITS infrastructure. Herein, the moving object may be used by being identified and authenticated through the identification device and perform communication with the above-described communicable apparatuses through the identification device. As another example, the identification device (e.g., USIM) of the smart device may be compatible with the identification device of the moving object. In addition, the identification device may be installed in another device equally with the moving object, thereby performing communication based on this and providing a service. As another example, one user may own the identification device of each device. That is, identification devices may be respectively installed in the devices and the user information indicated by the identification devices may be the same. That is, the same user may use the identification device based on the same user ID in various devices. Herein, for example, the moving object and the other device may be used to interwork based on the same user ID information. Herein, a plurality of devices is controlled based on the same user ID and the same user, thereby increasing security. In addition, each device may store information necessary for the user and then transmit information thereon to another device. For example, each device may periodically update the device usage history information of the user based on machine learning. Thereafter, the updated usage history information may be exchanged with the other device and the other device may be controlled based on information thereon. That is, the user may control various devices through a plurality of identification devices based on the same ID. Herein, charging information may be provided based on one user ID, thereby increasing user convenience.

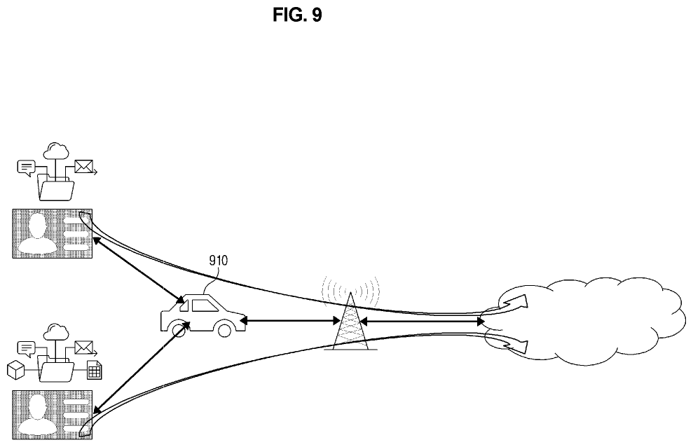

FIG. 9 is a view illustrating another example of moving object control information related to communication stored and managed in an identification device, according to an embodiment of the present disclosure.

As described above, when the moving object performs communication using the identification device, a vehicle communication fee may be determined based on moving object control information generated in the identification device.

That is, according to an embodiment of the present disclosure, service and data usage may be individually allowed to a plurality of users in one identification device. Herein, for example, charging information for service and data usage or data usage information may be managed as one. That is, when service provision is considered, a service may be provided to each of a plurality of users registered in one identification device but management of the service may be performed by the identification device, but the present disclosure is not limited thereto.

Referring to FIG. 9, service and data usage may be set with respect to a plurality of users. Herein, for example, charging information may also be set and managed with respect to each of the plurality of users. The user may use respective rate systems for vehicle communication, and perform communication via respective networks. That is, for example, when a user has logged in and has completed authentication, information on a network used by the identified user may be checked and communication of the moving object may be performed via the corresponding network. Herein, the users may use a first type network, a second type network, etc., respectively. In addition, the users may have different usages and rate systems. Accordingly, rate system information of each user and the amount of used data may be checked for each user. In addition, since services provided to the users are different, the services requested by the users may be managed for each user. Accordingly, moving object control information related to communication may be managed as user-specific information for each user according to an embodiment of the present disclosure.

In addition, for example, the identification device performs communication with neighbor IoT apparatuses and receive a service based on this. For example, the identification device may also be applied to the IoT devices. As a detailed example, although the identification device is currently applicable to only a smartphone, a plurality of identification devices compatible with each other and capable of identifying the same user is applicable to a plurality of apparatuses such as a smartphone, a moving object and a home appliance. That is, it is possible to provide services to a plurality of devices of the user through the identification device of the same user.

In addition, for example, when the moving object includes an identification device, the moving object may operate in combination with an ITS infrastructure. For example, in the case of autonomous driving of the moving object, the identification device may be recognized in the moving object and an autonomous driving service may be provided through a neighbor ITS infrastructure using the recognized identification device. Herein, user authentication may be performed through the identification device and a service may be provided based on the authenticated user information.

In addition, for example, services/security may be provided through the identification device. In addition, a sharing service such as a moving object sharing service may be provided.

In addition, for example, an ITS infrastructure or a traffic system may be controlled through the identification device of the moving object. For example, communication with a server or RSU may be performed through the identification device of the moving object, and control may be performed based on this.

As another example, a traffic infrastructure may be directly controlled in a moving object based on edge computing. For example, user authentication may be performed through the identification device of the moving object, and IoT or ITS infrastructures may be controlled. For example, at least one of street lights may be controlled based on the authenticated user, which is located in a region adjacent to the driving moving object. That is, it is possible to prevent delay and increase operational efficiency, by directly performing control through authentication with the neighbor infrastructure and the identification device of the moving object, instead of central control.

FIG. 10 is a view illustrating an example of a method of generating moving object control information stored and managed in an identification device, according to an embodiment of the present disclosure. More specifically, an example of generating moving object control information when a plurality of users uses a moving object based on one identification device is shown.

Referring to FIG. 10, the identification device may identify User A While User A uses the moving object, information on driving of User A may be stored in the identification device. Herein, the user may be switched to User B registered in the identification device. In this case, the identification device may authenticate and identify User B according to the login procedure of User B. When User B is authenticated, information on driving of the moving object by User B may be stored. That is, the driving information may be stored in the identification device for each user. Herein, the stored driving information may be updated as control information of the moving object. As described above, since the moving object control information may be divided into common information and user-specific information, the common information and the user-specific information may be divided and stored in the identification device in the update process.

For example, since entire statistical information may correspond to basic information of the moving object shared by all users, the information may be stored and managed as the common information. As the example of FIG. 10, common information such as total driving time information of User A and User B, total mileage of a vehicle or the amount of fuel may be stored, updated and managed as common information available to all registered users.

In addition, as another example, driving information of each user may be managed and updated as user-specific information. That is, user-specific information of each user may be generated and updated based on operation record statistical information of User A and operation record statistical information of User B. As anon-limiting example, a driving destination, a preferred driving mode, an average speed, seat settings, a used communication network, etc. of User A may be different from those of User B, and may be stored, updated and managed as information used and checked by User A In addition, the specific information of User A may correspond to basic information set in the moving object for User A to control the moving object when User A completes login authentication for the identification device.

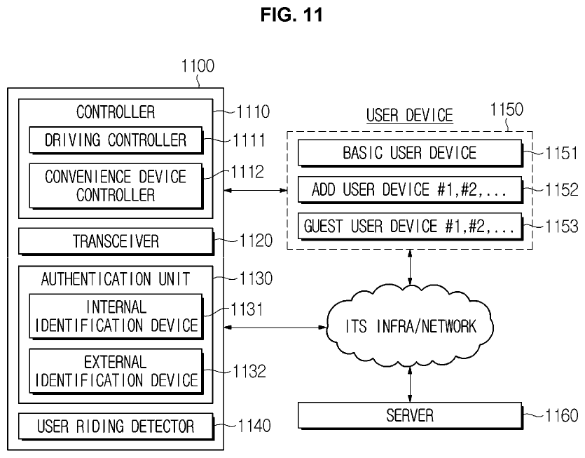

FIG. 11 is a view illustrating a system controlled by a moving object based on a user identified by an identification device according to an embodiment of the present disclosure.

First, the system of the present disclosure may include a moving object 1100, a user device 1150 and a server 1160. Herein, the user device 1150 may include all a basic user device 1151, an additional user device 1152 and a guest user device 1153. That is, the user device 1150 is distinguished from the moving object and is capable of performing communication. Herein, there may be a plurality of additional user devices 1152 and a plurality of guest user devices 1153.

First, the moving object 1100 may include a controller 1110, a transceiver 1120, an authentication unit 1130 and a user riding detector 1140.

The controller 1110 may include a driving controller 1111 and a convenience device controller 1112. The controller 1110 may correspond to the processor of the present disclosure. For example, the driving controller 1111 may be a module for managing operation of the moving object. That is, the driving controller 1111 may be a module for managing the engine and the other driving related hardware of the moving object such that the moving object physically operates. The convenience device controller 1112 may be a module which is not directly involved in physical operation of the moving object but is configured to manage components for increase user convenience in using of the moving object. For example, the convenience device controller 1112 may perform at least one of in-vehicle UI/UX management, navigation, air conditioning or automation system management. In addition, the controller 1110 may control operation of the components described below as the processor of the moving object.

The transceiver 1120 may receive login information of one of users registered in the authentication unit 1130 or perform data communication with an ITS infrastructure/network to transmit and receive necessary authentication information, moving object control information and user information.

The authentication unit 1130 may correspond to an identification device according to an embodiment of the present disclosure. In addition, the authentication unit 1130 may include at least one of an internal identification device 1131 embedded in the moving object or a detachable external identification device 1132.

According to an embodiment of the present disclosure, the authentication unit 1130 may identify a user based on login information and perform a login authentication procedure with respect to the user. Herein, the authentication unit 1130 may receive the login information from the transceiver 1120 of the moving object 1100 or the user device 1150 and perform a login authentication procedure. In addition, the authentication unit 1130 may receive the login information from the user device 1150 via the ITS infrastructure/network and perform the login authentication procedure with respect to the user, in a state in which the moving object 1100 is turned off or riding of the user is not detected. When the authentication unit 1130 identifies the user based on the login information, the user may be identified based on at least one of an authentication key, image recognition, fingerprint recognition, iris recognition, facial recognition or voice recognition.

According to another embodiment of the present disclosure, the authentication unit 1130 may register the user. When at least one user is registered in the authentication unit 1130, the authentication unit 1130 may receive user registration information corresponding to the unique information of the user who has requested user registration, and perform a registration authentication procedure with respect to the user based on the registration authentication information. In addition, the authentication unit 1130 may generate initial user information based on the user registration information, when the registration authentication procedure is completed.

In addition, according to another embodiment of the present disclosure, the authentication unit 1130 may add and register a user. In this case, the server 1160 may receive an additional request from the authentication unit 1130. In addition, the server 1160 may perform an additional authentication procedure based on the information received from the user device 1150.

In addition, according to another embodiment of the present disclosure, the authentication unit 1130 may perform the authentication procedure when a guest uses the moving object. Herein, when a guest who is not registered in the authentication unit 1130 operates the moving object, a guest identification device may be used. Herein, the gest identification device may be a detachable external identification device 1132.

In addition, according to an embodiment of the present disclosure, the authentication unit 1130 may generate and manage information for controlling the moving object 1100 based on information related to authentication and the identified user. First, the authentication unit 1130 may generate and manage the initial user information. Herein, the initial user information may include login information. In addition, the authentication unit 1130 may generate and manage moving object control information. Herein, the moving object control information may be generated based on the initial user information. The moving object control information may be divided into common information corresponding to all one or more users registered in the authentication unit 1130 and user-specific information corresponding to each of one or more users registered in the authentication unit 1130. In addition, the moving object control information may be updated based on the moving object driving information of the identified user. The moving object control information may include information on a type of a network used by the user, and the authentication unit 1130 may generate and manage the network type information as user-specific information of each user.

In addition, the authentication unit 1130 may distinguishably store, manage and update common information and user-specific information based on the moving object driving information of at least one user when at least one user registered in the authentication unit 1130 operates the moving object. Herein, the common information may include status information of the moving object 1100. In addition, the user-specific information may include at least one of a position of a driver's seat, a height of the driver's seat, a color of an interior lighting, brightness of the interior lighting, a position of a room mirror, an angle of the room mirror, a position of a side-view mirror, an angle of the side-view mirror, an inside temperature, an angle of a steering wheel, tire pressure, an autonomous driving function setting variable, a transmission setting mode, a dashboard mode, navigation settings, content settings, or a wireless communication connection mode.

The user riding detector 1140 may transmit a signal such that the moving object 1100 recognizes the identification device, that is, the authentication unit 1130, when the moving object is turned on or riding of the user is detected.

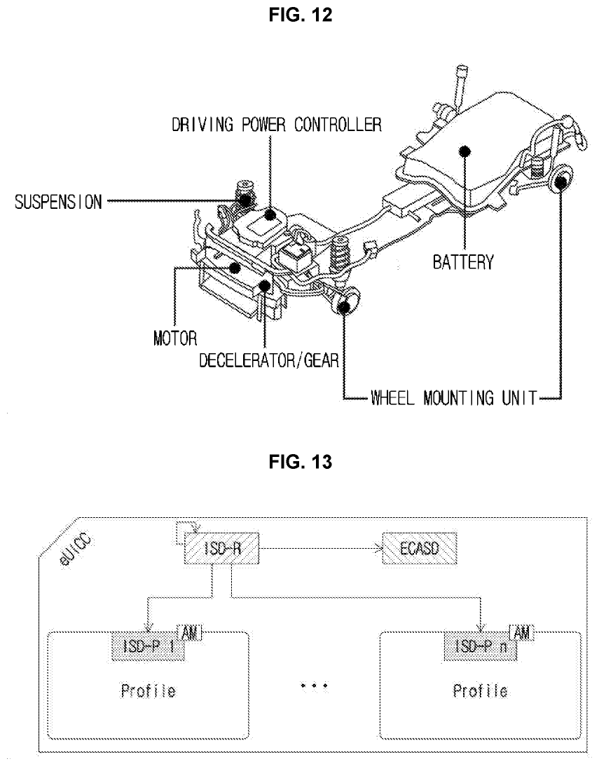

FIG. 12 is a view illustrating an example of a mobility power transmission system.

In the present disclosure, the moving object refers to an object which includes a motor, a decelerator, a gear, a driving and power controller, a battery, a suspension, a wheel mounting unit, etc. and may autonomously move. The present disclosure is not limited to the shape implemented in FIG. 12.

FIG. 13 is a view illustrating an operating method based on an embedded identification device. For example, as described above, the embedded identification device or an identification device may store profile information as shown in FIG. 11. Herein, for example, the profile information may be user related information or information stored for use of the moving object. Herein, for example, in consideration of security of the moving object and supplement of the identification device, a component accessible to the profile and a component for performing authentication with the moving object may be distinguished. That is, the component accessible to the profile in the embedded identification device may acquire information on control of the moving object from the profile and transmit the information to the component for performing authentication with the moving object. In addition, for example, operation based on a component other than the component disclosed in FIG. 13 is possible, but the present disclosure is not limited thereto.

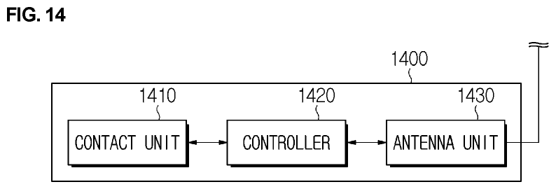

FIG. 14 is a view illustrating an identification device. Referring to FIG. 14, the identification device 1400 may include a contact unit 1410 which may be brought into contact with a moving object or another device for recognition. In addition, for example, the identification device 1400 may include a controller 1420 for controlling and managing operation based on the identification device 1400. In addition, the identification device 1400 may include an antenna unit 1430 for performing communication with another device and exchanging data. Herein, for example, the controller 1420 may manage the contact unit 1410 and the antenna unit 1430 and may control the other components. In addition, the above-described components may be implemented in hardware or software. That is, the above-described components may be physically included in the identification device 1400 or may be a software component operating based on the operation and function of the identification device 1400, but the present disclosure is not limited thereto.

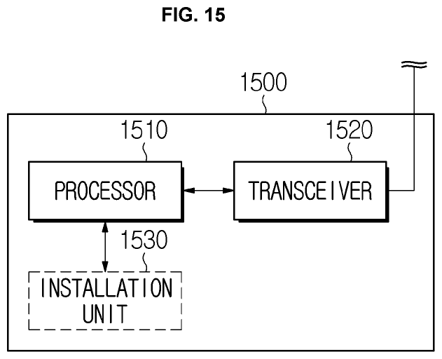

FIG. 15 is a view illustrating the configuration of an apparatus. Referring to FIG. 15, the apparatus may include at least one of the above-described moving object, a device, a server or an RSU. That is, the apparatus may communicate or cooperate with another device, but the present disclosure is not limited thereto. For example, the apparatus 1500 may include a processor 1510 and a transceiver 1520 for the above-described operation. That is, the apparatus may include a component necessary to perform communication with anther apparatus. In addition, for example, the apparatus may include components other than the above-described components. That is, the apparatus includes the above-described components in order to perform communication with another device, without being limited thereto, and may operate based on the foregoing.

In addition, for example, the apparatus 1500 may further include an installation unit 1530 in which another device (e.g., the identification device) is installed. Herein, the installation unit may be included in the moving object in the form shown in FIGS. 2A to 2D. For example, the installation unit 1530 may be implemented in any one area of the front side of the driver's seat in the moving object. In addition, for example, the installation unit 1530 may be implemented in the passenger seat kit inside the moving object. In addition, for example, the installation unit 1530 may be implemented in the mirror inside the moving object. In addition, for example, the installation unit 1530 may be implemented in the moving object in the form of a cradle or a paddle, as described above. That is, the apparatus 1500 may further include the installation unit 1530 for recognizing the identification device as another device, as described above, recognize another device based on the same, and perform authentication. For example, the installation unit 1530 may be implemented in the moving object. Herein, the installation unit 1530 may be implemented in the apparatus 1500 as a physical component. As another example, the installation unit 1530 may be implemented in the apparatus 1500 as a software component. Herein, when the installation unit 1530 is implemented in the apparatus 1500, the identification device may be implemented in the apparatus 1500 as a physical or software component as described above, but the present disclosure is not limited thereto.

According to the present disclosure, it is possible to control a moving object using an identification device.

According to the present disclosure, it is possible to identify a user of a moving object based on an identification device and provide a service to the identified user.

The technical problems solved by the present disclosure are not limited to the above technical problems and other technical problems which are not described herein will become apparent to those skilled in the art from the above description.

While the exemplary methods of the present disclosure described above are represented as a series of operations for clarity of description, it is not intended to limit the order in which the steps are performed, and the steps may be performed simultaneously or in a different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. A method of operating a moving object to which an identification device is applied, the method comprising:
receiving login information of a user of a plurality of users registered in the identification device;
determining a result of a login authentication procedure with respect to the user processed by identification device, wherein the login authentication procedure comprises identifying the user based on the login information; and
controlling the moving object based on moving object control information corresponding to the identified user when the login authentication procedure is completed.

2. The method according to claim 1, wherein the moving object control information comprises common information corresponding to the plurality of users registered in the identification device and user-specific information corresponding to each of the plurality of users registered in the identification device.

3. The method according to claim 2, wherein the moving object control information is updated based on moving object operation information of the identified user.

4. The method according to claim 2, wherein when at least one of the plurality of users registered in the identification device operates the moving object, the common information and the user-specific information are stored, managed and updated based on the moving object operation information of the at least one of the plurality of users.

5. The method according claim 2, wherein when at least one of the plurality of users is registered in the identification device, the identification device receives user registration information corresponding to unique information of the user who has requested user registration, and performs a registration authentication procedure with respect to the user based on registration authentication information.

6. The method according to claim 5, wherein when the registration authentication procedure is completed, initial user information is generated based on the user registration information.

7. The method according to claim 6, wherein the registration authentication information corresponds to information capable of being acquired from a user authorized for registration, and the initial user information includes the login information.

8. The method according to claim 6, wherein the moving object control information is generated based on the initial user information.

9. The method according to claim 2, wherein when a user is additionally registered in the identification device, a server receives an additional request from the identification device and performs an additional authentication procedure with respect to the additionally registered user based on information received from a user device.

10. The method according to claim 1, wherein the identification device is embedded in the moving object.

11. The method according to claim 1, wherein when a guest user who is not registered in the identification device operates the moving object, a guest identification device different from the identification device is used.

12. The method according to claim 11, wherein the guest identification device is detachable from the moving object.

13. The method according to claim 1, wherein when the moving object is turned on or riding of a user is detected, the moving object recognizes the identification device.

14. The method according to claim 1, wherein when end of use of the moving object by the user is detected, the moving object is locked.

15. The method according to claim 1, wherein when end of use of the moving object by the user is detected, the moving object control information is updated.

16. The method according to claim 1, wherein the identification device receives the login information from a moving object or a user device and performs the login authentication procedure.

17. The method according to claim 1, wherein the identification device receives login information from a user device via a network and performs a login authentication procedure with respect to the user, in a state in which the moving object is turned off or riding of the user is not detected.

18. A moving object to which an identification device is applied, the moving object comprising:
a transceiver configured to transmit and receive a signal; and
a processor configured to control the transceiver,
wherein the processor is configured to:
receive login information of a user of a plurality of users registered in the identification device, and determine a result of a login authentication procedure with respect to the user processed by identification device, wherein the login authentication procedure comprises identifying the user based on the login information; and
control the moving object based on moving object control information corresponding to the identified user when the login authentication procedure is completed.

19. A system of operating a moving object, the system comprising:
the moving object; and
an identification device,
wherein the moving object is configured to:
receive login information of a user of a plurality of users registered in the identification device, determine a result of a login authentication procedure with respect to the user processed by identification device, and control the moving object based on moving object control information corresponding to the identified user when the login authentication procedure is completed,
wherein the identification device is configured to:
identify the user based on the login information, and perform the login authentication procedure with respect to the user.
